(19) United States
(12) Patent Application Publication
(10) Pub. No.: US 2026/0281788 A1
(43) Pub. Date: Sep. 17, 2026

(54) GENERALIZED ARTIFICIAL INTELLIGENCE POWER AWARE TRAFFIC MANAGEMENT AS A SERVICE

(71) Applicants: AT&T Intellectual Property I, L.P., Atlanta, GA (US); AT&T Technical Services Company, Inc., Vienna, VA (US)

(72) Inventors: Daniel Vivanco, Ashburn, VA (US); Yupeng Jia, South Pasadena, CA (US)

(73) Assignees: AT&T Intellectual Property I, L.P., Atlanta, GA (US); AT&T Technical Services Company, Inc., Vienna, VA (US)

(21) Appl. No.: 19/081,164

(22) Filed: Mar. 17, 2025

(51) Int. Cl. H04W 28/02; H04L 43/0882

(52) U.S. Cl. CPC H04W 28/0221; H04L 43/0882; H04W 28/0289

(57) ABSTRACT

Aspects of the subject disclosure may include, for example, obtaining, from a plurality of gNodeBs in a mobile communication network, network load data and user equipment battery data for user equipment attached to gNodeBs of the plurality of gNodeBs, predicting a respective battery impact metric for a respective user equipment based on the network load data and the user equipment battery data and based on received traffic throttling levels and corresponding traffic volume, forming a predicted battery impact, and dynamically adjusting traffic throttling parameters in the mobile communications network based on the predicted battery impact and network congestion, thereby optimizing network performance and mitigating battery drainage. Other embodiments are disclosed.

### FIELD OF THE DISCLOSURE

The subject disclosure relates to a traffic management in a mobile communications network.

### BACKGROUND

In a mobile communications network, functional features of the core network can apply traffic management techniques such as throttling during congestion periods to manage network congestion. Traffic throttling may apply a rate cap to downloading and uploading data rates to some or all user equipment (UEs) that are using the core network. Traffic throttling may impact the usage experience for all the UEs connected to the network, resulting in, for example, longer downloading times.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts an illustrative embodiment of a method in accordance with various aspects described herein.

FIG. 2C depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for an artificial intelligence (AI) based power-aware traffic management system and method designed to optimize network performance and preserve battery life in mobile communications networks. The system and method predict the impact of traffic throttling on user equipment by analyzing network load and battery data, allowing for dynamic adjustments to throttling parameters based on real-time conditions. This system and method identify heavy users and prioritizes traffic management to prevent battery drainage of user devices, ensuring continuous service and enhanced user experience. Other embodiments are described in the subject disclosure.

One or more aspects of the subject disclosure include obtaining, from a plurality of gNodeBs in a mobile communication network, network load data and user equipment battery data for user equipment attached to gNodeBs of the plurality of gNodeBs, predicting a respective battery impact metric for a respective user equipment based on the network load data and the user equipment battery data and based on received traffic throttling levels and corresponding traffic volume, forming a predicted battery impact, and dynamically adjusting traffic throttling parameters in the mobile communications network based on the predicted battery impact and network congestion, thereby optimizing network performance and mitigating battery drainage.

One or more aspects of the subject disclosure include receiving information about core network traffic in a core network of a mobile communications network, the mobile communications network including a plurality of gNodeBs, wherein the gNodeBs of the plurality of gNodeBs are in data communication with the core network to provide communication services to user equipment attached to the plurality of gNodeBs, based on the information about the core network traffic, predicting a core network over-limit condition, the core network over-limit condition corresponding to the core network traffic level exceeding a predetermined traffic threshold in the core network, receiving user equipment battery data for the user equipment attached to the plurality of gNodeBs, predicting, for each user equipment of the user equipment attached to the plurality of gNodeBs, a respective battery impact metric based on the information about core network traffic, the user equipment battery data, and received traffic throttling levels for traffic throttling that may be imposed by the core network, wherein the predicting comprises deriving a predicted battery impact for the user equipment attached to the plurality of gNodeBs, and adjusting traffic throttling parameters in the mobile communications network based on the respective battery impact metric and the information about the core network traffic to prevent draining of a battery providing operating power to the user equipment of the user equipment attached to the plurality of gNodeBs.

One or more aspects of the subject disclosure include obtaining network load data and user equipment battery data from a plurality of gNodeBs in a mobile communications network, predicting, by the processing system, a battery impact metric for each user equipment, wherein the predicting is based on the network load data and user equipment battery data, and wherein the predicting is based on traffic throttling levels for traffic throttling in a core network of the mobile communications network, and corresponding traffic volume associated with the traffic throttling levels, wherein the predicting comprises deriving a predicted battery impact of traffic throttling for the user equipment, identifying by the processing system, heavy hitter user equipment that exhibits a relatively high network resource utilization, aggregating, by the processing system, battery impact metrics for user equipment attached to each gNodeB to derive an aggregate battery impact measure for each gNodeB, and adjusting, by the processing system, traffic throttling parameters for traffic in the mobile communications network based on the battery impact metric and a degree of network congestion in the mobile communications network.

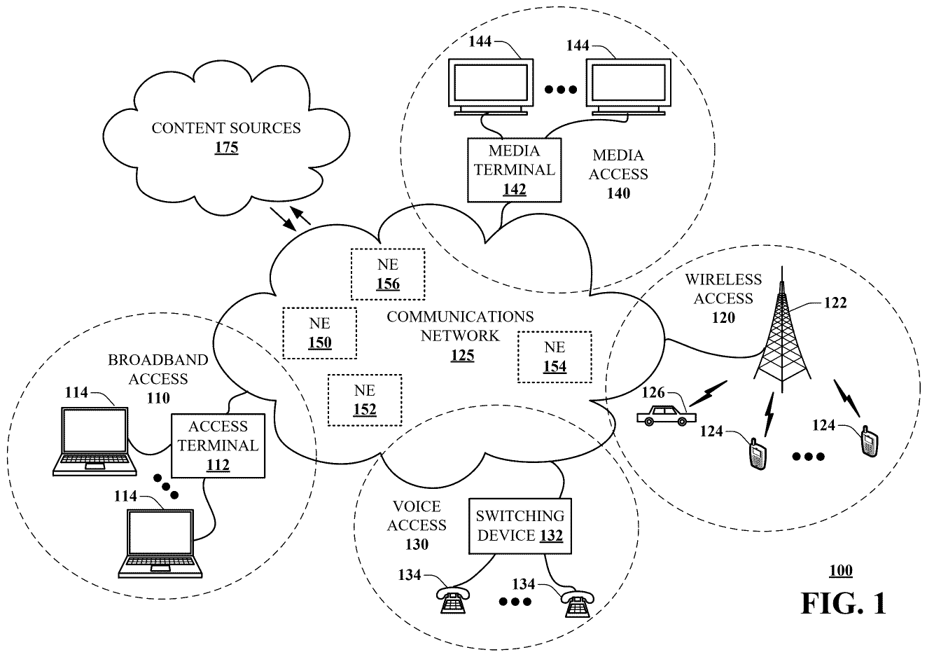

Referring now to FIG. 1, a block diagram is shown illustrating an example, non-limiting embodiment of a system 100 in accordance with various aspects described herein. For example, system 100 can facilitate in whole or in part predicting the impact of traffic throttling on user equipment by analyzing network load and battery data, allowing for dynamic adjustments to throttling parameters based on real-time conditions. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VOIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

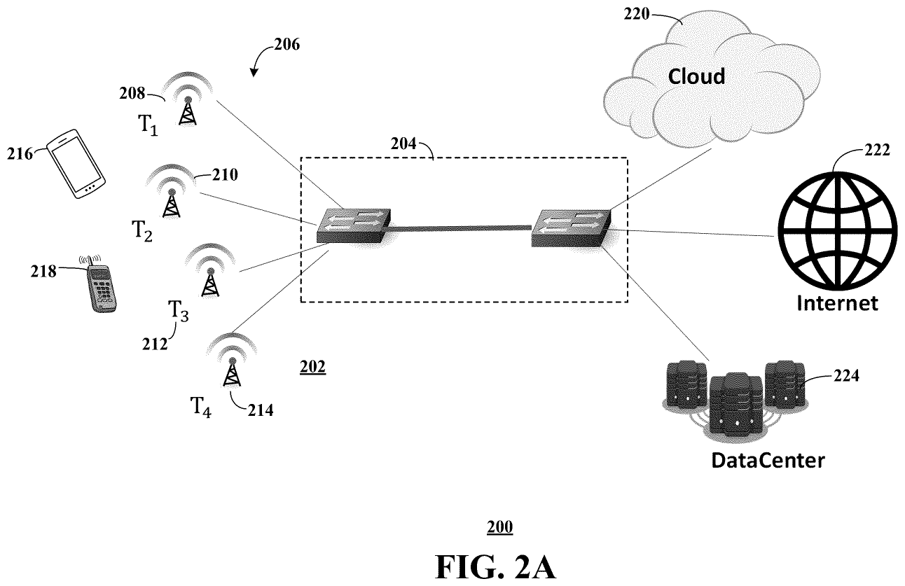

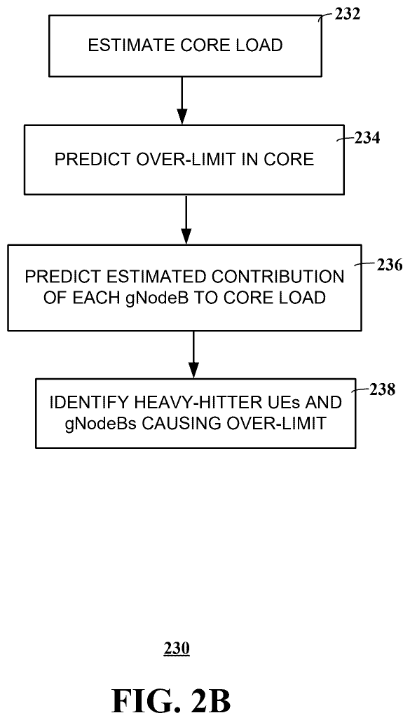

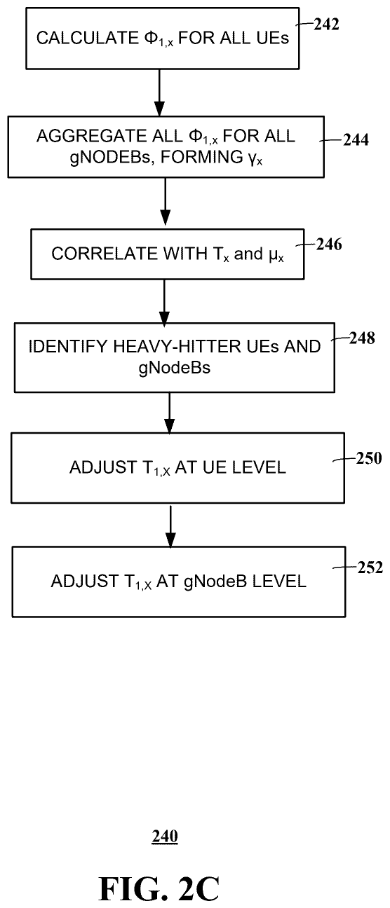

FIG. 2A is a block diagram illustrating an example, non-limiting embodiment of a system 200 functioning within the communications network 125 of FIG. 1 in accordance with various aspects described herein. FIG. 2A shows a block diagram of a mobile communications network 202 including a core network 204, a radio access network (RAN) 206 including a plurality of gNodeBs or gNBs in data communication with the core network 204 and user equipment (UEs) attached to one or more gNB. The mobile communications network 202 may include or be a part of the wireless access 120 of FIG. 1. The mobile communications network 202 provides radio communications to user equipment such as the UEs.

The core network 204 provides management and control of functional and physical features of the mobile communications network 202. The core network 204 is responsible for routing voice, data, and video traffic across the network. The core network 204 verifies the identity of users and determines whether they are authorized to access specific services. The core network 204 controls which services users can access, such as phone calls, text messaging, and internet data. The core network 204 provides mobility management including tracking the location of users as they move between different cell towers or gNBs, ensuring seamless connectivity. The core network 204 provides the routes to exchange information among different sub-networks, and also provides gateways to access other networks like the internet.

The RAN 206, including the plurality of gNBs in this example, includes gNB 208, gNB 210, gNB 212, and gNB 214. An embodiment of the mobile communications network 202 may include any suitable number of gNBs. Each respective gNB is responsible for providing radio connectivity between user equipment (UE) and the core network 204. In embodiments, the gNBs utilize 5G new radio (NR) technology, which enables significantly faster data speeds, lower latency, and increased network capacity. Each gNB provides communication services to a respective service area and manages radio resources for the service area.

The UEs may be any suitable communication device adapted for radio communication with one or more gNB. Examples includes mobile phones, smartphones, internet of things (IoT) devices and connected vehicles. In the example, the UEs include a smartphone 216 and a mobile phone 218. The UEs are generally mobile and powered by a battery or other depletable energy source. Reduction in battery drainage so as to extend operating life for the battery and the UE is generally desirable. Any suitable device may function as a UE in the mobile communications network 202.

The RAN 206 forms an access network for the UEs to access aspects of the core network 204. The UEs communicate with a gNB according to a published air interface standard such as the standards published by the 3G Partnership Project (3GPP). For mobility, the UEs may connect to two or more gNBs and hand off communication from a source gNB to a target gNB. This may be done to manage the movement of the UE among service areas as well as to manage demand for communication services by respective UEs. The radio link from a gNB to the UE is referred to as the downlink. The radio link from a UE to a gNB is referred to as the uplink.

The UEs may provide access to the widest range of services for users. For example, a UE such as mobile phone 218 provides voice call services for the user. The smartphone 216 may provide access to mobile applications including serving as a client to a remotely located server for user access. For such services, the mobile communications network including gNB access and operation of the core network 204, is largely invisible to the user and the UE.

The mobile communications network 202 may interact with other networks including cloud networks as exemplified by cloud network 220, the public internet 222 and data centers as exemplified by data center 224. Cloud networks such as cloud network 220 enable the delivery of computing services including access to servers, storage, databases, networking, software, analytics, and intelligence, over data networks such as the public internet 222 to offer faster innovation, flexible resources, and economies of scale. Instead of storing data or running applications on a local computer or server of the mobile communications network 202, cloud functions use remote servers located in data centers that may be anywhere around the world.

The public internet 222 provides data access to a wide variety of sources and destinations. For example, a user of a UE may seek to access an application such as a gaming application provided at a website accessible over the public internet. Similarly, data centers such as the data center 224 provide storage, retrieval and data processing for the mobile communications network 202.

Access to these external networks is managed through the core network 204. For example, as noted a user of a UE may wish to access a gaming at a remote network site. The core network 204 operates to manage the radio resources between the UE and the gNB and to manage access to the network resource. Further, the core network 204 operates to ensure the UE receives adequate resources such as bandwidth in order to maintain a required quality of experience (QoE) level. For example, some applications such as online gaming or two-way, 4K video, require substantial bandwidth over an extended period for the particular UE, which may be mobile.

Thus, some new service applications, such as 4K video, have induced large traffic increases in both the RAN 206 and the core network 204 in the past years for mobile network operators. This traffic demand has tended to increase and result in network overload. The core network 204 can be required to handle traffic associated with many network locations. A typical access network such as RAN 206 may include hundreds of gNBs. Each gNB can in turn serve hundreds of UEs. Core network load depends on the individual traffic contribution of all UEs attached to the communications network 202. Some UEs may be running heavy bandwidth-applications, such as 4K video, and therefore create larger contribution to congestion of the core network 204. These may be referred to as heavy-hitters UEs, which are devices running applications that have very high requirements for network resources.

The core network 204 can apply traffic management techniques, such as throttling, during congestion periods to alleviate the network congestion. Throttling is an intentional reduction in data transfer speeds to one or more subscribers or UEs. Traffic throttling may apply a rate cap to downloading data rates or uploading data rates to some or all UEs that are using the core network 204. Traffic throttling may impact usage experience for all the UEs connected to the network. For example, such throttling may result in longer downloading times experienced by a user at a particular UE. Generally, if a user wants to download a content item, the downloading will occur sooner or later. If the user gets more bandwidth, the download will occur faster. If the user gets less bandwidth, the download will take longer to complete. The longer operation may impact the battery which provides operating power to the UE, including the radio transmission and reception circuitry of the radio. Presence of a few heavy-hitters UEs may thus result in network overload and traffic throttling for many users.

Core traffic throttling may generally be applied to all UEs connected to the communications network 202, regardless of the type of application that the UEs are running. One exception is devices assigned to first responders which generally get highest priority in the network. Core traffic throttling may result in longer downloading times and uploading times for a particular UE and a particular application. This may result in unexpectedly rapid battery drainage for many UEs in the network.

In the example based on FIG. 2A, for simplicity, four gNBs are connected to the core network 204. Each gNB has a number of UEs connected to the gNB. The combined network load of these gNBs may exceed a maximum load of the core network 204 and therefore control operations of the core network 204 initiate traffic throttling for all UEs in the mobile communications network 202. For example, the core network or some function of the core network may receive information about the level of traffic in the core network, where the traffic is associated with UEs in the network. The level of traffic may be routinely compared with a threshold level of traffic to identify an over-limit condition. In response to the over limit condition, the core network automatically begins traffic throttling for all UEs. The value T₁ denotes the traffic throttling level for gNB₁ and so on, i.e, T₁=2 Mbps as an example. Conventional or standard traffic throttling mechanisms may use the same throttling level for all gNBs, i.e., in the example of FIG. 2A, T₁=T₂=T₃=T₄.

The UEs in the network may be engaged in multiple applications, such as artificial intelligence functions and 4K video. Plus, UEs may be connected to cloud servers, data centers, or the public internet as shown in FIG. 2A. Heavy-hitters UEs may be located in or attached to one or a few gNBs in the RAN 206. Traffic throttling may induce larger downloading times which may result in battery drainage issues for many UEs.

To address the issue of battery drainage among users during times of heavy usage and congestion, a methodology may operate to identify so-called heavy hitters and propose solutions based on how much battery life is going to be impacted. This methodology includes an algorithm that monitors UE battery usage and correlates against core traffic throttling level to accomplish an efficient AI-based power aware traffic management mechanism aiming to prevent UE battery drainage when core traffic throttling is applied. This solution can adjust traffic throttling at the UE or gNB level to avoid UE battery drainage, while maintaining quality of experience (QoE) requirements for users on the network.

In accordance with various aspects described herein, a novel AI-based power-aware traffic management mechanism is designed to address the challenges of network congestion and battery drainage in mobile communications networks such as the mobile communication network 202. One key aspect lies in the ability to estimate and predict core network load, identifying heavy traffic sources to enable proactive resource management. This approach is complemented by a unique method for predicting the impact of traffic throttling on battery life and download times, which facilitates more efficient management of user equipment (UE) battery usage during periods of congestion.

Additionally, some aspects described herein employ a new approach to aggregate and monitor battery impact and traffic load for each gNB and UE, allowing for precise adjustments in traffic management. The intelligent AI system dynamically manages traffic to prevent battery drain during network congestion by identifying and adjusting heavy users, both UEs and gNBs. This capability is further enhanced by an ability to make targeted adjustments to traffic throttling at the UE or gNodeB level, optimizing network performance and battery life while maintaining quality of experience (QoE) requirements.

Moreover, aspects described herein include special handling for UEs with critical battery levels to avoid disconnection, ensuring continuous service for users with low battery. These novel features collectively provide a comprehensive solution that enhances network efficiency, user experience, and battery preservation, setting it apart from existing traffic management techniques.

FIG. 2B depicts an illustrative embodiment of a method 230 in accordance with various aspects described herein. FIG. 2B illustrates method 230 for managing network traffic and battery life in a mobile communications network. The method 230 may be performed by any suitable device in the system 100 (FIG. 1) or in a mobile communications network 202, such as in the core network 204.

The method 230 begins with step 232, which involves estimating the core load of the communications network 125 depicted in FIG. 1. In embodiments, the receives data from elements of the core network 204 as well as elements of the RAN 206 including the gNodeBs in the RAN 206. The received data may include any suitable information about the traffic load in the core network 204. For example, the core network 204 may include a user plane function that enables UEs such as UE 216 to access an application at a location in the cloud 220 for playing an interactive virtual reality game. This application generates substantial traffic through the core network 204 and the RAN 206 and a gNodeB such as gNodeB 210. Moreover, if the game involves real-time game play, the access by the UE 216 may be very high priority and be assigned, for example, a high quality of service (QoS). These aspects correspond to a large load on the core network 204 and may qualify the UE 216 as a heavy hitter, or as user equipment having very high requirements for network resources. Thus, the UE 216 may be designated as a heavy hitter as well as the gNodeB to which it is attached, such as gNodeB 210 in FIG. 2A. Such requirements may include a relatively large amount of bandwidth compared with other users, a relatively short latency requirement compared to other users, or a relatively high priority as measured by QoS or other factors, again relative to other users.

On the other hand, the received data for estimating core load may include information about activities of the mobile phone 218. In an example, the mobile phone 218 is engaged in a voice call which is a relatively low-traffic activity. Therefore, mobile phone 218 is not a heavy hitter but the estimated data traffic for the voice call is used for estimating the core load at step 232. In a further example, the mobile phone 218 is assigned to a first responder and therefore has the highest priority on the network, such as by assignment of a relatively high priority QoS value. That factor is taken into account in step 232 when estimating core load in the core network 204.

Step 234 involves predicting an over-limit condition in the core network 204, as shown in FIG. 2A. This prediction is based on the aggregated data from multiple gNodeBs, such as gNB 208, gNB 210, gNB 212, and gNB 214, which are part of the radio access network (RAN) 206. The core network 204 interfaces with external networks like the cloud 220, internet 222, and data center 224, which contribute to the overall network load. A maximum core network load may be defined for the core network 204, such as 2 Tbps, for example. The sum of the traffic load due to the UEs and gNodeBs in the RAN 206 may be compared with the maximum core network load to predict the over-limit condition. In some examples, historical data such as time-of-day data and day-of-week data that defines a busy hour in the network may be used for step 234 as well.

Step 236 focuses on predicting the estimated contribution of each gNodeB to the core load. This step is crucial for understanding the impact of traffic from specific gNodeBs, such as those depicted in FIG. 2A, on the performance of the core network 204.

Finally, step 238 involves identifying heavy-hitter UEs and gNodeBs that are responsible for the over-limit condition. This identification allows for targeted traffic management where traffic throttling parameters are dynamically adjusted to optimize network performance and mitigate battery drainage in individual UEs. The method links the detailed network architecture and traffic management strategies depicted in FIGS. 1 and 2A to the predictive and adaptive capabilities outlined in FIG. 2B.

FIG. 2C depicts an illustrative embodiment of a method 240 in accordance with various aspects described herein. The method 240 may be performed by any suitable device in the system 100 (FIG. 1) or in a mobile communications network 202, such as in the core network 204.

FIG. 2C provides a comprehensive method 240 for implementing an AI-based power-aware traffic management system within a mobile communications network, such as mobile communications network 202 in FIG. 2A. More specifically, method 240 may be used to predict the impact of traffic throttling versus battery preservation level for all the UEs that will be impacted by traffic throttling in the network when the core network is near or over its traffic limit. For example, traffic throttling to a UE may result in longer downloading times as the throttling operation reduces the bandwidth assigned to the UE. This longer downloading time may impact UE battery life as the UE must remain active on the network, downloading data over an extended time period, all while depleting the battery.

In the method 240, UE battery reduction rates may be calculated for all UEs impacted by traffic throttling. Further, these battery reduction rates may be correlated against actual battery level and grouped per gNodeB. In one example, φ_{1,x} is defined as the battery reduction level UE₁ which is attached to gNBₓ and has been impacted by traffic throttling. φ_{1,x} can be calculated after traffic throttling, or it can be estimated before traffic throttling, based on prediction models such as a machine learning model. Any suitable machine learning model may be selected. Large φ_{1,x} denotes that UE₁ is experiencing long download times and thus its battery may drain quickly. Large φ_{1,x} also represents that the traffic throttling rate T₁ is much greater than required data rates of UE₁.

The method 240 can aggregate φ_{1,x} of all UEs attached to gNBₓ which is denoted as γₓ. Note that, γₓ can be average or weighted average (based on UE Priority) of all UEs attached to gNBₓ.

The method 240 can monitor and predict {φ_{i,x} γₓ} for all UEs and gNodeBs connected to the core network, and correlate against the corresponding {T_{i,x}, Tₓ} and μ_{1,x}. Here, μ_{1,x} represents the traffic volume of UE₁ which is attached to gNBₓ. Heavy hitter UEs are mapped to large μ_{1,x}.

The method 240 may use all the dimensions above to accomplish an efficient AI-based power aware traffic management mechanism aiming to prevent UE battery drainage when core traffic throttling is applied. In one embodiment, the proposed solution can identify UE heavy hitters based on μ_{1,x} and decide to adjust T_{i,x} at the UE level to improve overall φ_{i,x} at the UE level. In a second embodiment, the method 240 can identify gNB heavy contributors based on γₓ and decide to adjust Tₓ at the gNB level to improve γₓ at the gNB level. In a third embodiment, the method 240 can identify a UE with critical φ_{i,x} and decide not to adjust its T_{i,x} to avoid UE disconnection from the mobile communications network as the UE batter expires and is completely depleted.

The method 240 begins with step 242, where the system calculates the battery impact metric φ_{1,x} for all user equipment (UEs) connected to the RAN 206 of the mobile communications network 202. This calculation is based on data from the communications network 125 in FIG. 1, which includes various access technologies such as wireless access 120 and supported by network elements like NE 150, 152, 154, and 156, which facilitate the collection of network load and battery data. The calculation of φ_{1,x} involves analyzing the current battery levels, historical usage patterns, and predicted battery life of the UEs, as well as the traffic they generate. In examples, the core network 204 or some predetermined function of the core network may request the current battery level or historical battery level information from UEs in the RAN 206. In another embodiment, each UE may routinely report its current battery level to the network along with other status information for the UE. The function within the core network 204 may operate to collect and process the battery information received from the UEs.

In step 244 all φ_{1,x} values are aggregated for UEs across all gNodeBs, forming an aggregate battery impact measure designated γₓ. This aggregation is useful for understanding the overall impact of traffic throttling on battery resources of UEs in the network. The aggregation process may involve averaging of UE battery levels or using a weighted average of UE battery levels wherein the weighting may be based on user equipment priority or service level agreements. For example, a UE accessing an application with a relatively high QoS value may receive a higher priority than a UE currently operating under a relatively lower QoS value, and the relative priority may be used to develop a weighted average for the aggregate battery impact measure γₓ.

In step 246, the aggregated battery impact measure γₓ is correlated with traffic throttling levels Tₓ and traffic volume μₓ. This correlation helps identify the relationship between network congestion and battery drainage, enabling more precise traffic management. The correlation process involves analyzing how different traffic throttling levels affect battery life and download times, allowing the method 240 to predict the impact of various throttling strategies.

Step 248 involves identifying heavy-hitter UEs and gNodeBs that significantly contribute to network congestion and battery impact. Heavy-hitter UEs are those that exhibit relatively high network resource utilization, often due to running bandwidth-intensive applications like 4K video streaming. Such heavy-hitter UEs therefore make a larger contribution to the core network congestion. Heavy-hitter UEs are devices running applications that have very high requirements for network resources. Identifying these heavy hitters allows the system to target them specifically for traffic management, reducing their impact on the network and other users.

Finally, step 250 and step 252 involve embodiments of adjusting the traffic throttling parameters T_{1,x} at both the UE level and the gNodeB level, respectively. Either or both of step 250 or step 252 may be practiced in embodiments of the method 240. These adjustments are based on the identified heavy hitters and the correlated battery impact, ensuring that network performance is optimized while minimizing battery drainage. At the UE level, adjustments may involve capping download and upload data rates for specific devices, while at the gNodeB level, adjustments may involve modifying the overall traffic management strategy for the entire cell. This method, as depicted in FIG. 2C, links the network architecture and traffic management strategies from FIGS. 1 and 2A to the predictive and adaptive capabilities outlined in the invention disclosure and claims, providing a comprehensive solution for managing network traffic and preserving battery life.

The system and method as illustrated and exemplified herein provide a number of benefits to network operation. First, the system and method estimates the core network load and predicts potential overload stages. By analyzing observations and predictions, the system and method calculate the contribution of each gNodeB's traffic to the core load and identifies the heavy-hitter UEs and their associated gNodeBs. Second, the system and method predicts the impact of traffic throttling on battery life for all affected UEs, considering longer download times that may impact UE battery performance. The system and method calculate the UE battery reduction rate for all UEs impacted by traffic throttling, correlates this with the actual battery level, and groups them by gNodeB. Third, the system and method use these dimensions to create an efficient AI-based power-aware traffic management mechanism aimed at preventing UE battery drainage when core traffic throttling is applied.

Alternate embodiments of the subject disclosure may involve various implementations of the AI-based power-aware traffic management system, utilizing different technologies and methodologies to enhance network performance and battery preservation. One alternative embodiment involves distributed AI processing, where AI capabilities are decentralized across multiple gNodeBs, allowing each to independently analyze local network load and battery data for more localized traffic management decisions. This reduces latency and improves responsiveness to real-time network conditions. Another alternative embodiment integrates edge computing resources at the gNodeB level, enhancing the system's ability to process large volumes of data quickly. By deploying edge servers, the system may perform real-time analytics and machine learning tasks closer to the data source, improving the accuracy and speed of battery impact predictions and traffic management adjustments.

Additionally, the system and method may employ adaptive machine learning models that continuously learn and update based on new data inputs, incorporating user feedback, environmental changes, and evolving network conditions to refine predictions and optimize traffic throttling strategies dynamically. A hybrid traffic management approach may also be implemented, combining AI-based predictions with rule-based algorithms to handle predictable network scenarios while AI models address more complex and dynamic conditions. User-centric customization options may be offered, allowing individual users to set preferences for battery preservation versus network performance, with the system adjusting traffic management strategies accordingly.

Furthermore, the system and method may expand to include Internet of Things (IoT) devices, providing additional data points for network load and battery impact analysis. IoT devices may report their battery status and network usage, contributing to a more comprehensive understanding of network conditions and user equipment needs. Another embodiment employs cross-network collaboration, where the system collaborates with other networks, such as Wi-Fi or satellite networks, to optimize traffic management across different communication platforms, enhancing connectivity and battery preservation for users transitioning between network types. Lastly, the system may incorporate predictive maintenance alerts for network infrastructure, using AI models to forecast potential hardware failures or performance degradation, ensuring network reliability and minimizing disruptions that impact user experience and battery life. These alternate embodiments demonstrate the flexibility and adaptability of the subject disclosure, allowing it to be tailored to various network environments and user needs while maintaining the core objectives of optimizing network performance and preserving UE battery life.

While for purposes of simplicity of explanation, the respective processes are shown and described as a series of blocks in FIG. 2B and FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

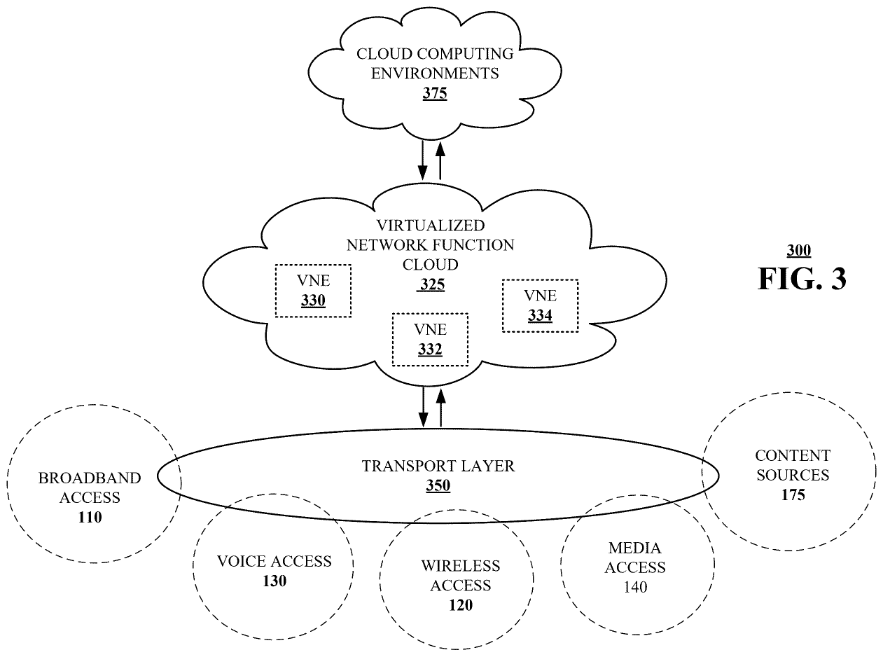

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of system 100, the subsystems and functions of mobile communications system 200, and method 230 presented in FIG. 1, FIG. 2A, FIG. 2B, FIG. 2C, and FIG. 3. For example, virtualized communication network 300 can facilitate in whole or in part predicting the impact of traffic throttling on user equipment by analyzing network load and battery data, allowing for dynamic adjustments to throttling parameters based on real-time conditions.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. At other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

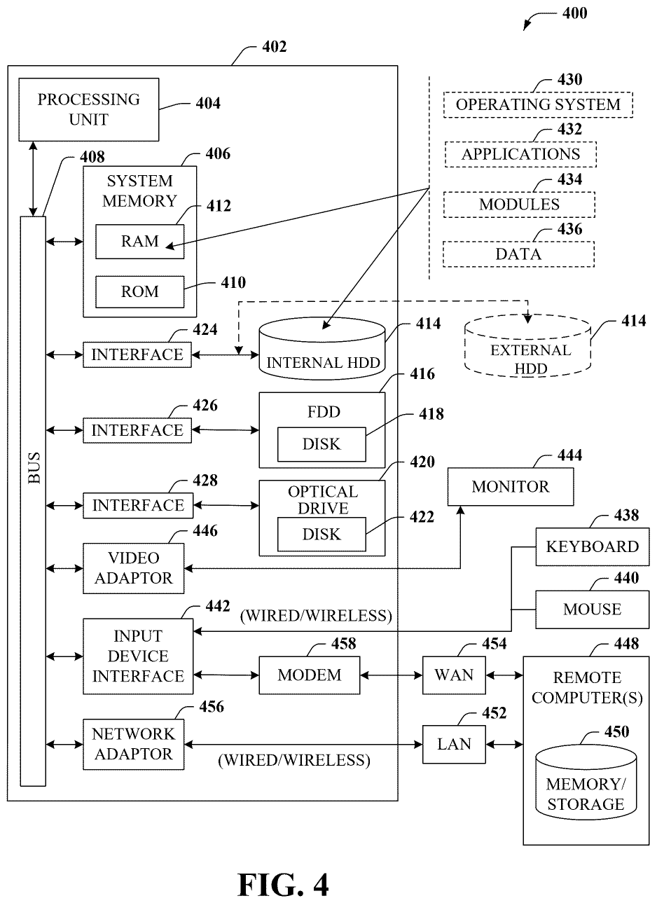

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part predicting the impact of traffic throttling on user equipment by analyzing network load and battery data, allowing for dynamic adjustments to throttling parameters based on real-time conditions.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are exemplary and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

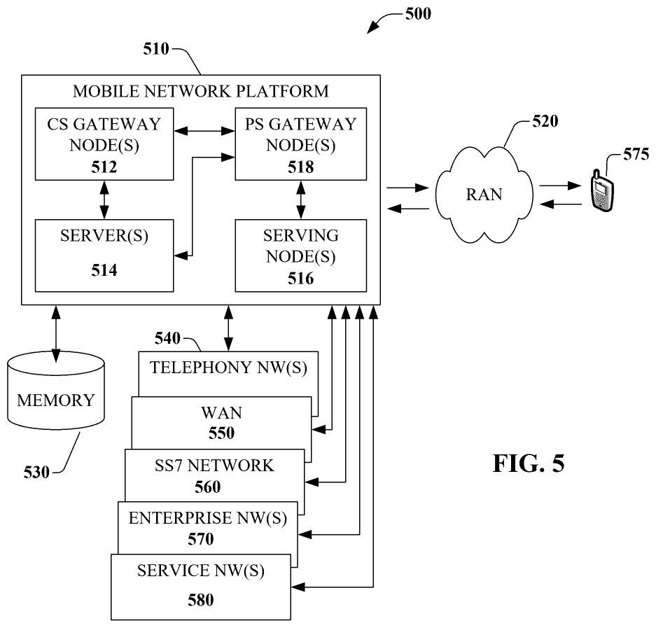

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part predicting the impact of traffic throttling on user equipment by analyzing network load and battery data, allowing for dynamic adjustments to throttling parameters based on real-time conditions. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

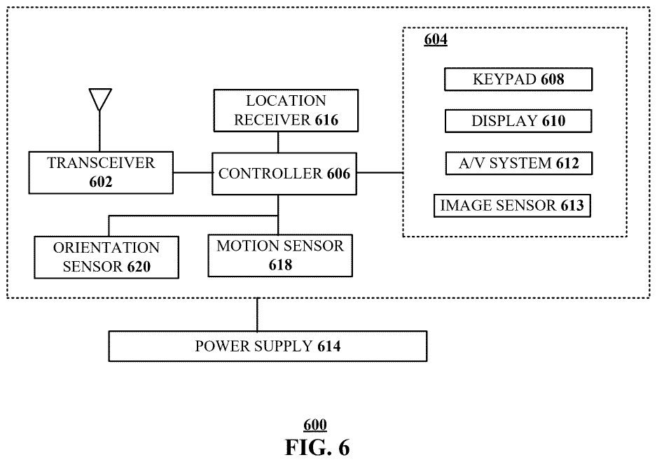

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part predicting the impact of traffic throttling on user equipment by analyzing network load and battery data, allowing for dynamic adjustments to throttling parameters based on real-time conditions.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
obtaining, from a plurality of gNodeBs in a mobile communication network, network load data and user equipment battery data for user equipment attached to gNodeBs of the plurality of gNodeBs;
predicting a respective battery impact metric for a respective user equipment based on the network load data and the user equipment battery data and based on received traffic throttling levels and corresponding traffic volume, forming a predicted battery impact; and
dynamically adjusting traffic throttling parameters in the mobile communications network based on the predicted battery impact and network congestion, thereby optimizing network performance and mitigating battery drainage.

2. The device of claim 1, wherein the dynamically adjusting traffic throttling parameters comprises:
identifying one or more heavy hitter user equipment having very high requirements for network resources; and
adjusting traffic throttling parameters for individual user equipment to improve a battery reduction level for respective user equipment, wherein the adjusting is based on the identifying the one or more heavy hitter user equipment.

3. The device of claim 1, wherein the dynamically adjusting traffic throttling parameters comprises:
aggregating respective battery impact metrics for user equipment attached to each gNodeB to derive an aggregate battery impact measure; and
adjusting traffic throttling parameters for respective gNodeBs of the plurality of gNodeBs or for individual user equipment, wherein the adjusting the traffic throttling parameters is based on the aggregate battery impact measure.

4. The device of claim 3, wherein the aggregating the respective battery impact metrics comprises:
averaging respective battery impact metrics for respective user equipment attached to a gNodeB to derive the aggregate battery impact measure.

5. The device of claim 3, wherein the aggregating the respective battery impact metrics comprises:
determining a user equipment priority for each respective user equipment attached to the gNodeB; and
determining a weighted average of respective battery impact metrics for respective user equipment attached to a gNodeB to derive the aggregate battery impact measure, wherein the respective battery impact metrics are weighted according to the user equipment priority for the respective user equipment.

6. The device of claim 1, wherein the user equipment battery data comprises:
receiving information about current battery levels, current battery drainage levels and predicted battery life for respective user equipment.

7. The device of claim 1, wherein the predicting a respective battery impact metric comprises:
determining a battery reduction level for the respective user equipment based on historical traffic throttling in the mobile communication network, wherein a relatively larger battery reduction level for the respective user equipment corresponds to a likelihood of a battery powering the respective user equipment draining relatively more quickly.

8. The device of claim 1, wherein the operations further com wherein the predicting a respective battery impact metric comprises:
predicting a battery reduction level for the respective user equipment based on modeling of traffic throttling in the mobile communication network by a machine learning model.

9. The device of claim 1, wherein the dynamically adjusting traffic throttling parameters comprises:
capping a download data rate, an upload data rate, or both, to some or all user equipment attached to one or more gNodeB of the plurality of gNodeBs.

10. The device of claim 1, wherein the operations further comprise:
identifying a user equipment having a critical user equipment battery level, forming a critical UE; and
excluding the critical UE from the dynamically adjusting traffic throttling parameters to avoid draining a battery of the critical UE.

11. A non-transitory machine-readable medium, comprising executable instructions that, when executed by a processing system including a processor, facilitate performance of operations, the operations comprising:
receiving information about core network traffic in a core network of a mobile communications network, the mobile communications network including a plurality of gNodeBs, wherein the gNodeBs of the plurality of gNodeBs are in data communication with the core network to provide communication services to user equipment attached to the plurality of gNodeBs;
based on the information about the core network traffic, predicting a core network over-limit condition, the core network over-limit condition corresponding to a level of the core network traffic exceeding a predetermined traffic threshold in the core network;
receiving user equipment battery data for the user equipment attached to the plurality of gNodeBs;
predicting, for each user equipment of the user equipment attached to the plurality of gNodeBs, a respective battery impact metric based on the information about core network traffic, the user equipment battery data, and received traffic throttling levels for traffic throttling that may be imposed by the core network, wherein the predicting comprises deriving a predicted battery impact for the user equipment attached to the plurality of gNodeBs; and
dynamically adjusting traffic throttling parameters in the mobile communications network based on the respective battery impact metric and the information about the core network traffic to prevent draining of a battery providing operating power to the user equipment of the user equipment attached to the plurality of gNodeBs.

12. The non-transitory machine-readable medium of claim 11, wherein the operations further comprise:
aggregating respective battery impact metrics for user equipment attached to a gNodeB to derive an aggregate battery impact measure; and
adjusting traffic throttling parameters for respective gNodeBs of the plurality of gNodeBs or for individual user equipment, wherein the adjusting the traffic throttling parameters is based on the aggregate battery impact measure.

13. The non-transitory machine-readable medium of claim 12, wherein the aggregating the respective battery impact metrics comprises:
averaging respective battery impact metrics for respective user equipment attached to a gNodeB to derive the aggregate battery impact measure.

14. The non-transitory machine-readable medium of claim 11, wherein the dynamically adjusting traffic throttling parameters comprises:
predicting a battery reduction level for a respective user equipment based on modeling of traffic throttling in the mobile communication network; and
capping a download data rate, an upload data rate, or both, to some or all user equipment attached to one or more gNodeBs of the plurality of gNodeBs.

15. The non-transitory machine-readable medium of claim 11, wherein the operations further comprise:
identifying a user equipment having a critical user equipment battery level, forming a critical UE; and
excluding the critical UE from the dynamically adjusting traffic throttling parameters in order to avoid draining a battery which supplies operating power to the critical UE.

16. A method, comprising:
obtaining, by a processing system including a processor, network load data and user equipment battery data from a plurality of gNodeBs in a mobile communications network;
predicting, by the processing system, a battery impact metric for each user equipment, wherein the predicting is based on the network load data and user equipment battery data, and wherein the predicting is based on traffic throttling levels for traffic throttling in a core network of the mobile communications network, and corresponding traffic volume associated with the traffic throttling levels, wherein the predicting comprises deriving a predicted battery impact of traffic throttling for the user equipment;
identifying by the processing system, heavy hitter user equipment that exhibits a relatively high network resource utilization;
aggregating, by the processing system, battery impact metrics for user equipment attached to each gNodeB to derive an aggregate battery impact measure for each gNodeB; and
adjusting, by the processing system, traffic throttling parameters for traffic in the mobile communications network based on the battery impact metric and a degree of network congestion in the mobile communications network.

17. The method of claim 16, wherein the adjusting the traffic throttling parameters comprises:
adjusting, by the processing system, the traffic throttling parameters for the plurality of gNodeBs to improve the aggregate battery impact measure for each gNodeB.

18. The method of claim 16, wherein the adjusting the traffic throttling parameters comprises:
adjusting, by the processing system, the traffic throttling parameters for individual user equipment to improve the battery impact metric for each user equipment.

19. The method of claim 16, comprising:
identifying, by the processing system, a user equipment having a critical user equipment battery level, forming a critical UE; and
excluding, by the processing system, the critical UE from the adjusting the traffic throttling parameters to avoid draining a battery of the critical UE.

20. The method of claim 16, wherein the aggregating of battery impact metrics for user equipment attached to each gNodeB comprises:
employing, by the processing system, a weighted aggregation method that considers user equipment priority or service level agreements.
